(19) United States
(12) Patent Application Publication
(10) Pub. No.: US 2008/0162006 A1
(43) Pub. Date: Jul. 3, 2008

(54) Power system

(75) Inventors: James W. Landes, East Peoria, IL (US); Maarten Verkiel, Peterborough (GB); Charles E. Rose, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/647,144

(22) Filed: Dec. 29, 2006

(51) Int. Cl. G06F 7/00; G06F 19/00

(52) U.S. Cl. 701/54; 701/101

(57) ABSTRACT

A power system includes an engine that has engine controls, a power load, and a torque converter connected between the engine and the power load. The engine controls may operate the engine according to a first control strategy in at least some circumstances. The first control strategy may provide higher engine fuel efficiency at a first combination of engine speed and torque that corresponds to a drive speed/reaction torque band of the torque converter than it provides at combinations of engine speed and torque that do not correspond to the drive speed/reaction torque band of the torque converter. Additionally, at one or more combinations of engine speed and torque other than the first combination, the first control strategy may cause the engine to produce a lower quantity of at least one noxious exhaust emission than the engine produces at the first combination of engine speed and torque when operated according to the first control strategy.

### TECHNICAL FIELD

The present disclosure relates to power systems and, more particularly, to power systems that use a torque converter to transmit power between an engine and a power load.

### BACKGROUND

Many power systems use a torque converter to transmit power from an engine to a power load in at least some circumstances. For example, the propulsion systems of many mobile machines use a torque converter to transfer power from an engine to a drive train in at least some circumstances. Transmitting power from an engine to a power load with a torque converter may limit operation of the engine to certain combinations of engine speed and torque output because the reaction torque that the torque converter exerts against the engine may depend on how fast the engine drives it. Some power systems with a torque converter connected to an engine use an engine-control strategy configured to maximize fuel efficiency of the engine at a combination of engine speed and torque output that the engine cannot achieve when transmitting power through the torque converter. This may compromise fuel efficiency when the engine transmits power through the torque converter to a power load.

U.S. Pat. No. 6,095,117 to Minowa et al. (“the '117 patent”) discloses a power train system with a controller that considers the operating characteristics of a torque converter in the power train system when deciding how to control the power train system's engine. The power train system disclosed by the '117 patent includes an engine, a transmission, and a torque converter connected between the engine and the transmission. The power train system of the '117 patent also includes a controller that controls the engine and the transmission. The '117 patent discloses that the controller considers the operating characteristics of the torque converter and various other factors to identify a throttle opening and air/fuel ratio that will minimize fuel consumption.

Although the controller of the '117 patent considers the operating characteristics of the power train system's torque converter to identify a throttle opening and air/fuel ratio that will minimize fuel consumption, certain disadvantages persist. In some circumstances, operating an engine in a manner that minimizes fuel consumption may produce more noxious emissions than operating the engine in some other manner. Accordingly, simply controlling the engine in a manner that minimizes fuel efficiency may result in undesirably high average emissions.

The power system and control methods of the present disclosure solve one or more of the problems set forth above.

### SUMMARY OF THE INVENTION

One disclosed embodiment relates to a power system that includes an engine having engine controls. The power system may further include a power load and a torque converter connected between the engine and the power load. The engine controls may operate the engine according to a first control strategy in at least some circumstances. The first control strategy may provide a higher engine fuel efficiency at a first combination of engine speed and torque that corresponds to a drive speed/reaction torque band of the torque converter than it does at combinations of engine speed and torque that do not correspond to the drive speed/reaction torque band. Additionally, at one or more combinations of engine speed and torque other than the first combination, the first control strategy may cause the engine to produce a lower quantity of at least one noxious exhaust emission than the engine produces at the first combination of engine speed and torque when operated according to the first control strategy.

Another embodiment relates to a method of operating a power system that has an engine, a power load, and a torque converter connected between the engine and the power load. The method may include operating the engine according to a first control strategy in at least some circumstances. The first control strategy may provide higher engine fuel efficiency at first combination of engine speed and torque that corresponds to the a drive speed/reaction torque band of the torque converter than it does at combinations of engine speed and torque that do not correspond to the drive speed/reaction torque band of the torque converter. Additionally, at one or more combinations of engine speed and torque other than the first combination, the first control strategy may cause the engine to produce a lower quantity of at least one noxious exhaust emission than the engine produces at the first combination of engine speed and torque when operated according to the first control strategy.

A further disclosed embodiment relates to a power system that includes an engine having engine controls. The power system may also include a power load and a torque converter connected between the engine and the power load. Additionally, the power system may include a clutch having an input side drivingly connected to the engine and an output side drivingly connected to the power load. The engine controls may operate the engine according to a first control strategy in response to the clutch being disengaged, and the engine controls may operate the engine according to a second control strategy in response to the clutch being engaged.

### BRIEF DESCRIPTION OF THE DRAWINGS

FIG. 1 is a diagrammatic illustration of a machine having one embodiment of a power system according to the present disclosure;

FIG. 2 is a graphical illustration of one example of the operating characteristics of a torque converter;

FIG. 3 is a graphical illustration of the operating characteristics of a torque converter from FIG. 2 in combination with operating characteristics of an engine that may result from one control strategy according to the present disclosure;

FIG. 4 is a flow chart illustrating one method of selecting a control strategy for an engine of a power system; and

FIG. 5 is a graphical illustration of operating characteristics of an engine that may result from another control strategy according to the present disclosure.

### DETAILED DESCRIPTION

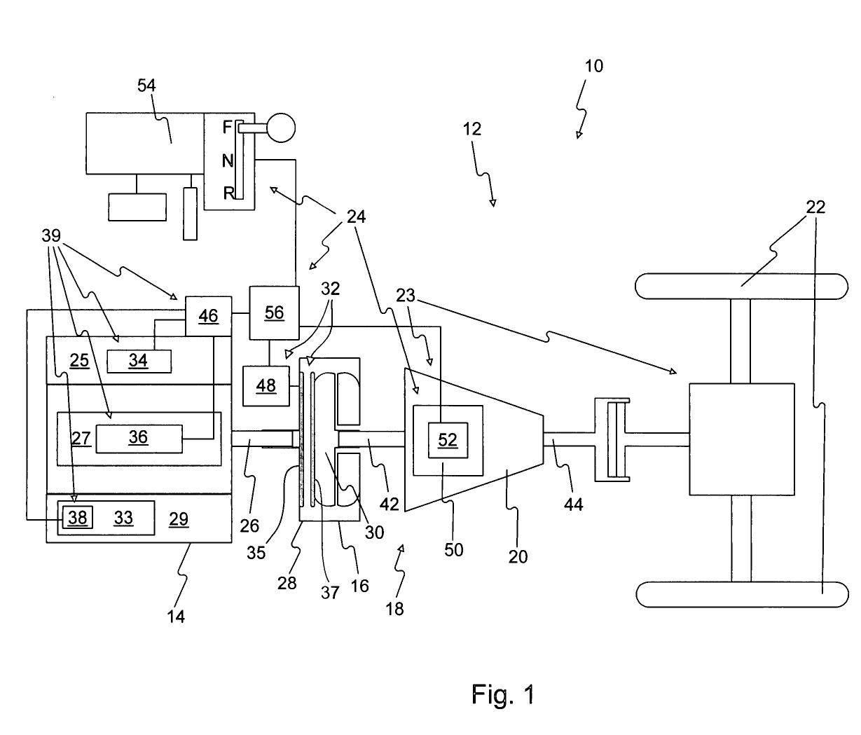

FIG. 1 illustrates a machine 10 having one embodiment of a power system 12 according to the present disclosure. Power system 12 may include an engine 14, a power load 18, a torque converter 16 connected between engine 14 and power load 18, a clutch 32, and power-system controls 24.

Engine 14 may be any type of device operable to produce mechanical power by combusting fuel, including, but not limited to, a diesel engine, a gasoline engine, a gaseous-fuel-driven engine, and a turbine engine. Engine 14 may have a rotary output member 26, an intake system 25, a fuel system 27, an exhaust system 29, and engine controls 39. Intake system 25 may supply air, and, in some cases, one or more other substances, to the combustion chamber(s) (not shown) of engine 14. Fuel system 27 may deliver fuel directly into the combustion chamber(s) of engine 14 and/or into intake system 25 for delivery to the combustion chamber(s).

Exhaust system 29 may direct combustion gas away from the combustion chamber(s) of engine 14. Exhaust system 29 may include an exhaust aftertreatment system 33. Exhaust aftertreatment system 33 may include various components for reducing the quantity of one or more noxious substances in exhaust gas produced by engine 14. For example, exhaust aftertreatment system 33 may including one or more particulate traps, oxidation catalysts, urea SCR systems, NOₓ absorbers, and/or any other suitable device or system for reducing the quantity of one or more noxious substances in the exhaust gas produced by engine 14.

Engine controls 39 may include any components that control one or more aspects of the operation of engine 14. For example, engine controls 39 may include control components 34 of intake system 25, control components 36 of fuel system 27 and control components of 38 of exhaust aftertreatment system 33. Control components 34 of intake system 25 may include various components and/or systems for adjusting the amount of air supplied to the combustion chamber(s) of engine 14, including, but not limited to, throttles, variable-output superchargers, and variable-valve-timing systems. Control components 36 of fuel system 27 may include various components for metering fuel, including, but not limited to, fuel injectors, variable-output pumps, valves, and carburetors. Control components 38 of exhaust aftertreatment system 38 may include any components for controlling one or more aspects of the aftertreatment devices thereof. For example, control components 38 may include components for controlling regeneration of one or more particulate filters, components for controlling urea supply for a urea SCR device, components for controlling operation of an oxidation catalyst, and/or any other suitable components for controlling one more aspects of the operation of exhaust aftertreatment system 33.

Engine controls 39 may also include an engine controller 46. Engine controller 46 may be any type of information-processing device. Engine controller 46 may include one or more processors and one or more memory devices. Engine controller 46 may be operatively connected to control components 34, 36 so that engine controller 46 may control one or more aspects of the delivery of air and fuel to the combustion chamber(s) of engine 14. Engine controller 46 may also be connected to various other components that provide engine controller 46 with information about various operating conditions of engine 14. For example, engine controls 39 may include sensors (not shown) that provide engine controller 46 with information such as the position and/or speed of rotary output member 26, the temperature of engine 14, the temperature of exhaust gas from engine 14, the temperature and/or pressure of gas in intake system 25, and/or various other aspects of the operation of engine 14.

Engine 14 is not limited to the configuration shown in FIG. 1. Engine 14 may omit one or more of the systems shown in FIG. 1. Additionally, in some embodiments, engine 14 may include one or more components or systems not shown in FIG. 1, such as a spark-ignition system for igniting fuel in the combustion chamber(s) of engine 14.

Power load 18 may include various components for performing various tasks with power from engine 14. As FIG. 1 shows, in some embodiments, power load 18 may include one or more propulsion devices 22 for propelling machine 10 and various provisions for transferring power produced by engine 14 to propulsion devices 22. Propulsion devices 22 may include any type of device operable to receive power produced by engine 14 and apply that power to the environment surrounding machine 10 to propel it. For example, as FIG. 1 shows, propulsion devices 22 may include wheels. The provisions for transmitting power produced by engine 14 to propulsion devices 22 may include a drive train 23 with a rotary input member 42 and one or more components for transferring power from rotary input member 42 to propulsion devices 22.

As FIG. 1 shows, in some embodiments, rotary input member 42 may be a rotary input member of a transmission 20. In addition to rotary input member 42, transmission 20 may include a rotary output member 44, provisions for transferring power between rotary input member 42 and rotary output member 44, and transmission controls 50. Transmission controls 50 may include any components that control one or more aspects of the operation of transmission 20. In some embodiments, transmission controls 50 may include a transmission controller 52 operatively connected to various other control components (not shown), such as valves, actuators, and sensors.

Power load 18 is not limited to the configuration shown in FIG. 1. Drive train 23 may have a different configuration than FIG. 1 shows. Additionally, power load 18 may include various other power-consuming devices and/or systems in addition to, or in place of, drive train 23 and propulsion devices 22, including, but not limited to, generators, pumps, and fans.

Torque converter 16 may include a rotary member 28 connected to rotary output member 26 of engine 14 and a rotary member 30 connected to rotary input member 42 of power load 18. As FIG. 1 shows, rotary member 28 and rotary member 30 may connect directly to rotary output member 26 and rotary input member 42, respectively. Alternatively, power system 12 may include various components connected between rotary member 28 and rotary output member 26 and/or various components connected between rotary member 30 and rotary input member 42.

Clutch 32 may have an input side 35 drivingly connected to rotary output member 26 of engine 14 and an output side 37 drivingly connected to rotary input member 42 of power load 18. As a result, the engaged operating state of clutch 32 may allow mechanically transferring power between engine 14 and power load 18 through clutch 32, and the disengaged operating state of clutch 32 may allow torque converter 16 to use fluid to transfer power between engine 14 and power load 18 in the manner discussed above. Input side 35 and output side 37 of clutch 32 may be drivingly connected to rotary output member 26 and rotary input member 42, respectively, in various ways. As FIG. 1 shows, in some embodiments, input side 35 may be drivingly connected to rotary member 28 of torque converter 16, and output side 37 may be drivingly connected to rotary member 30 of torque converter 16. Clutch 32 may include clutch controls 48 for controlling the operating state of clutch 32. Clutch controls 48 may include various types of actuators for engaging and disengaging clutch 32.

Power-system controls 24 may include engine controls 39, clutch controls 48, transmission controls 50, an operator interface 54, and a master controller 56. Operator interface 54 may include various components that transmit operator inputs to other components of power system 12. For example, operator interface 54 may include components for transmitting operator inputs relating to whether, in what direction, and how fast the operator desires power system 12 to propel machine 10.

Master controller 56 may be any type of information-processing device. Master controller 56 may include one or more processors (not shown) and one or more memory devices (not shown). Master controller 56 may be operatively connected to engine controller 46, clutch controls 48, transmission controller 52, operator interface 54, and various other sources of information about various operating conditions of power system 12 and machine 10. Accordingly, master controller 56 may coordinate operation of engine 14, transmission 20, and clutch 32 based on operator inputs received through operator interface 54 and various operating conditions of power system 12 and machine 10.

Power system 12 is not limited to the configuration shown in FIG. 1. For example, power system 12 may omit clutch 32. Additionally, power-system controls 24 may include other controllers. Alternatively, power-system controls 24 may include one controller in place of two or more of engine controller 46, transmission controller 52, and master controller 56. Similarly, power-system controls 24 may have various other types of control components in place of one or more of engine controller 46, transmission controller 52, and master controller 56, including, but not limited to, hard-wired control circuits, mechanical controls, hydraulic controls, and/or pneumatic controls. Additionally, power system 12 may have clutch controls 48 incorporated in transmission controls 50.

### INDUSTRIAL APPLICABILITY

Power system 12 may have application for performing any task that consumes power. For example, where power load 18 includes propulsion devices 22, power system 12 may have application for propelling machine 10 by transmitting power from rotary output member 26 of engine 14 to rotary input member 42 of power load 18 and, from there, to propulsion devices 22.

During operation of power system 12, power-system controls 24 may coordinate control of engine 14 and clutch 32 in various ways to meet the power needs of power load 18 in various circumstances. In some circumstances, power-system controls 24 may disengage clutch 32 so that torque converter 16 transmits power between engine 14 and rotary input member 42 while allowing the speed ratio between engine 14 and rotary input member 42 to vary. In such circumstances, the speed of rotary member 28 may determine the maximum amount of reaction torque that torque converter 16 can exert on engine 14 and the minimum amount of reaction torque that torque converter 16 can exert on engine 14. In other words, the range of reaction torque that torque converter 16 can exert on engine 14 may depend on the speed at which engine 14 drives rotary member 28.

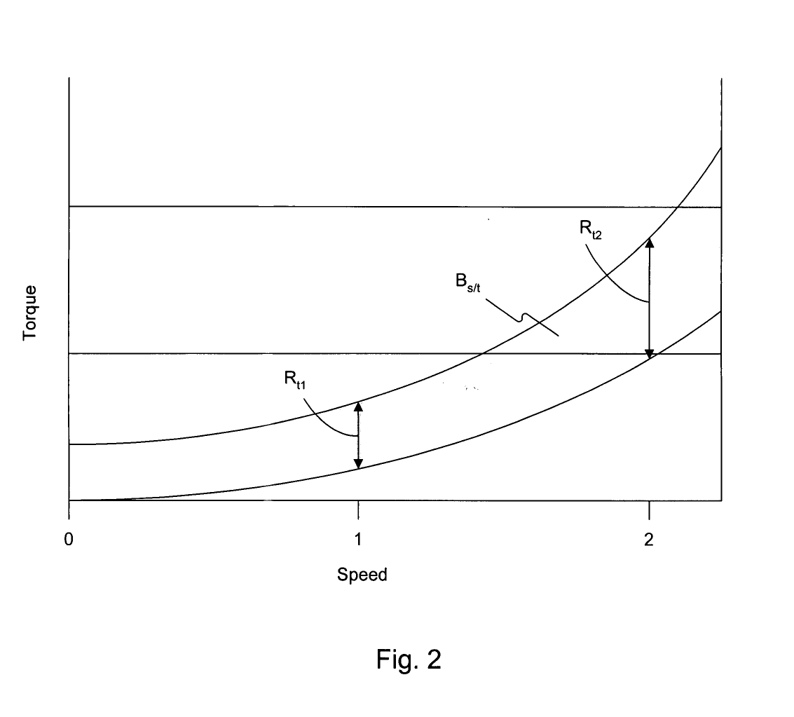

FIG. 2 provides one example of how the range of reaction torque that torque converter 16 can exert on engine 14 may vary as a function of drive speed. At each drive speed, torque converter 16 may have a range Rₜ within which the reaction torque it exerts on engine 14 may vary. For example, at speed 1, torque converter 16 may have a range Rₜ₁ within which the reaction torque may vary, and at speed 2, torque converter 16 may have a range Rₜ₂ within which the reaction torque may vary. For purposes of this disclosure, the set of all reaction torque ranges Rₜ₀-Rₜₙ for all possible drive speeds may constitute a drive speed/reaction torque band B_{s/t} of torque converter 16.

Accordingly, with clutch 32 disengaged, engine controls 39 may adjust the power supplied to power load 18 by adjusting engine operation between different engine speed/torque combinations that correspond to drive speed/reaction torque band B_{s/t} of torque converter 16. In embodiments where engine 14 drives rotary member 28 at a 1:1 speed ratio, engine speed/torque combinations corresponding to drive speed/reaction torque band B_{s/t} include engine speed/torque combinations equal to the drive speed/reaction torque combinations composing drive speed/reaction torque band B_{s/t}. In other embodiments, these engine speed/torque combinations may include the drive speed/reaction torque combinations of B_{s/t} adjusted for the drive ratio between engine 14 and rotary member 28.

When transitioning engine 14 between various combinations of engine speed/torque that correspond to drive speed/reaction torque band B_{s/t} of torque converter 16, engine controls 39 may adjust various aspects of the operation of engine 14. For example, engine controls 39 may adjust air delivery to the combustion chamber(s) of engine 14 by intake system 25, fuel delivery by fuel system 27, operation of exhaust aftertreatment system 33, and/or various other aspects of the operation of engine 14. Engine controls 39 may employ various strategies for controlling such aspects of the operation of engine 14 to provide the power required by power load 18 while advancing one or more other objectives.

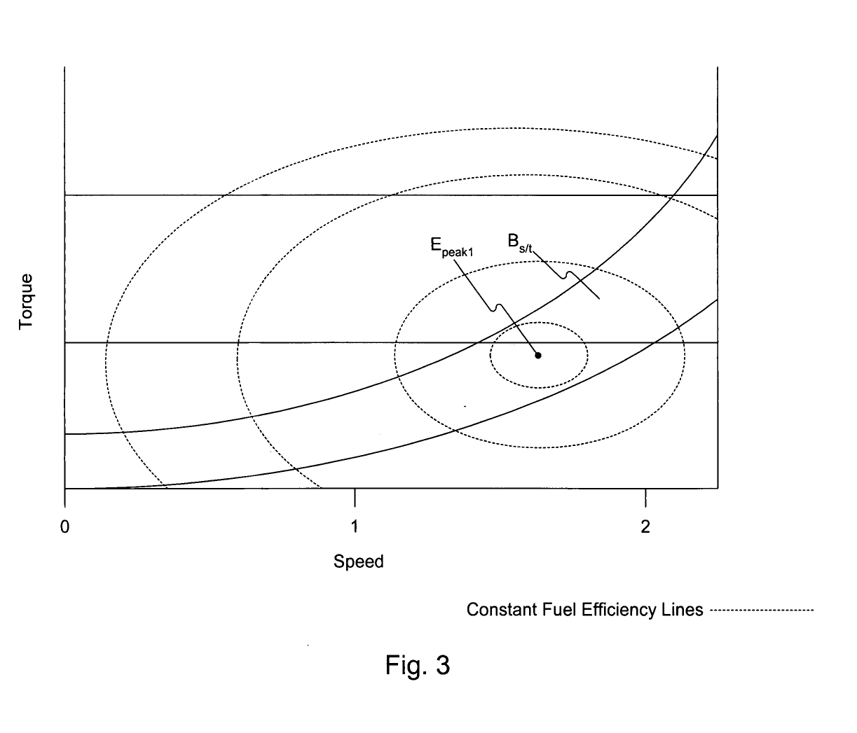

In some embodiments, engine controls 39 may employ a control strategy that provides high engine fuel efficiency at one or more combinations of engine speed and torque corresponding to drive speed/reaction torque band B_{s/t}. For example, engine controls 39 may employ a control strategy that causes engine speed, engine torque, and engine fuel efficiency to interrelate in the manner illustrated in FIG. 3. In this example, engine fuel efficiency has its peak value at a combination of engine speed and torque Eₚₑₐₖ₁ corresponding to drive speed/reaction torque band B_{s/t}, and engine fuel efficiency decreases as engine speed and torque deviate from Eₚₑₐₖ₁. Thus, such an exemplary control strategy provides higher engine fuel efficiency at Eₚₑₐₖ₁ than at combinations of engine speed and torque that do not correspond to drive speed/reaction torque band B_{s/t}. Of course, the control strategy may also produce higher engine fuel efficiency at one or more other combinations of engine speed and torque that correspond to drive speed/reaction torque band B_{s/t} (such as one or more combinations close to Eₚₑₐₖ₁) than at combinations of engine speed and torque that do not correspond to drive speed/reaction torque band B_{s/t}.

The same control strategy that causes engine speed, engine torque, and engine fuel efficiency to interrelate in the manners discussed in connection with FIG. 3, may suppress the quantity of noxious exhaust emissions produced by engine 14 at one or more combinations of engine speed and torque. In some embodiments, at one or more combinations of engine speed and torque other than Eₚₑₐₖ₁, the control strategy may cause engine 14 to produce a lower quantity of one or more noxious exhaust emissions than it does at Eₚₑₐₖ₁. Such noxious exhaust emissions may include, but are not limited to, oxides of nitrogen (NOₓ), unburned hydrocarbons, carbon monoxide, and particulates.

In some circumstances, power-system controls 24 may engage clutch 32 so that engine 14 transmits torque through clutch 32 to rotary input member 42 of power load 18. When engaged, clutch 32 may transmit any amount of torque (up to its maximum capacity) at any operating speed. Accordingly, with clutch 32 engaged, engine controls 39 may adjust the power supplied to power load 18 by adjusting the torque output and speed of engine 14 independently. In some embodiments, when clutch 32 is engaged, engine controls 39 may tend to operate engine 14 at lower speeds and higher torque outputs than when clutch 32 is disengaged.

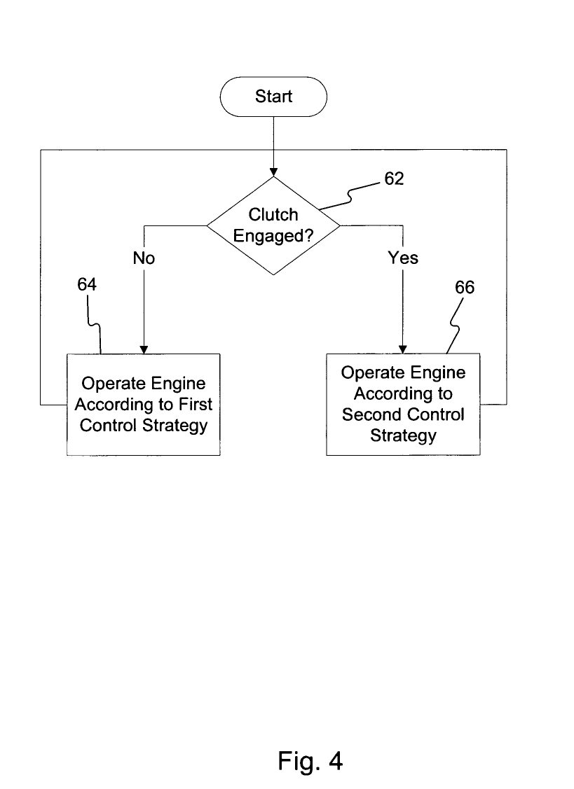

When clutch 32 is disengaged, engine controls 39 may operate engine 14 according to various control strategies. In some embodiments, engine controls 39 may operate engine 14 according to the same control strategy when clutch 32 is engaged as when clutch 32 is disengaged. Alternatively, engine controls 39 may execute a method that includes operating engine 14 according to different control strategies dependent at least partially on whether clutch 32 is engaged. FIG. 4 provides one example of such a method. As FIG. 4 shows, engine controls 39 may initially determine the operating state of clutch 32 using inputs from one or more other components of power system 12 (step 62). If engine controls 39 determine that clutch 32 is disengaged, engine controls 39 may operate engine 14 according to a first control strategy (step 64). If engine controls 39 determine that clutch 32 is engaged, engine controls 39 may operate engine 14 according to a second control strategy (step 66).

The first control strategy and the second control strategy may each include various provisions for controlling one or more aspects of the operation of engine 14. For example, in some embodiments, the first control strategy may include a first fuel map, and the second predetermined control strategy may include a second fuel map. Each fuel map may define how fuel system 27 delivers fuel in various different circumstances that may occur while engine 14 is producing power.

The substantive structure of each of the first control strategy and the second control strategy may take various different forms that give engine 14 various different operating characteristics. In some embodiments, the first control strategy may provide higher engine fuel efficiency at one or more combinations of engine speed and torque corresponding to drive speed/reaction torque band B_{s/t} of torque converter 16 than at combinations of engine speed and torque that do not correspond to drive speed/reaction torque band B_{s/t}. For example, as discussed above in connection with FIG. 3, the first control strategy may provide higher engine fuel efficiency at a combination of engine speed and torque Eₚₑₐₖ₁ that corresponds to drive speed/reaction torque band B_{s/t} than at combinations of speed and torque that do not correspond to drive speed/reaction torque band B_{s/t}. Additionally, at one or more combinations of engine speed and torque other than Eₚₑₐₖ₁, the first control strategy may cause engine 14 to produce a lower quantity of one or more noxious exhaust emissions than it does at Eₚₑₐₖ₁.

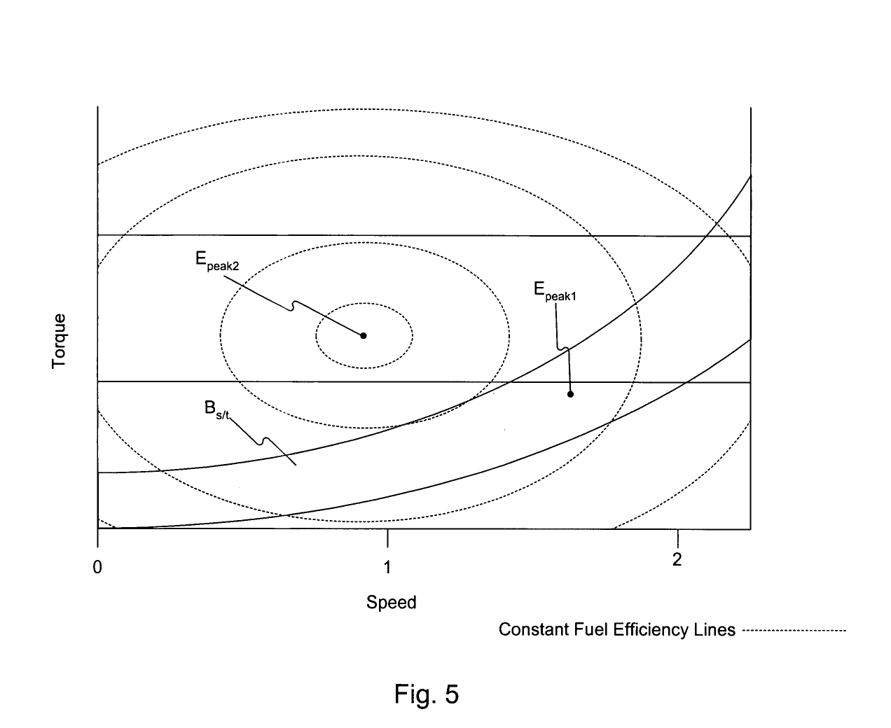

The second control strategy may provide engine 14 with operating characteristics that differ from those provided by the first control strategy in various ways. In some embodiments, the second control strategy may provide a different relationship between engine speed, engine torque, and engine fuel efficiency than the first control strategy does. For example, the second control strategy may cause engine speed, engine torque, and engine fuel efficiency to interrelate in the manner shown in FIG. 5. In this example, engine fuel efficiency has its peak value at an engine speed/torque combination Eₚₑₐₖ₂, and engine fuel efficiency decreases as engine speed and torque deviate from Eₚₑₐₖ₂. As a result, engine 14 may achieve higher fuel efficiency when operated according to the second control strategy at the combination of engine speed and torque Eₚₑₐₖ₂ than it does when operated according to the second control strategy at the combination of engine speed and torque Eₚₑₐₖ₁. As FIG. 5 shows, in some embodiments, Eₚₑₐₖ₂ may not correspond to the drive speed/reaction torque band B_{s/t} of torque converter 16, and Eₚₑₐₖ₂ may occur at a lower engine speed than Eₚₑₐₖ₁.

Similar to the first control strategy, the second control strategy may suppress the quantity of noxious exhaust emissions produced by engine 14 at one or more combinations of engine speed and torque. In some embodiments, at one or more combinations of engine speed and torque other than Eₚₑₐₖ₂, the second control strategy may cause engine 14 to produce a lower quantity of one or more noxious exhaust emissions than it does at Eₚₑₐₖ₂. Such noxious exhaust emissions may include, but are not limited to NOₓ, unburned hydrocarbons, carbon monoxide, and particulates.

Control methods that power-system controls 24 may employ to control power system 12 are not limited to the examples provided above. For instance, the first control strategy may provide operating characteristics different than those shown in FIG. 3 and/or the second control strategy may provide operating characteristics different from those shown in FIG. 5. Additionally, engine controls 39 may use more factors than just the operating state of clutch 32 to determine whether to operate engine 14 according to the first control strategy or the second control strategy. Furthermore, engine controls 39 may always execute a control strategy that provides high engine fuel efficiency at a combination of speed and torque corresponding to the drive speed/reaction torque band B_{s/t} of torque converter 16. Alternatively, in some embodiments, in some embodiments, engine controls 39 may select between more than two control strategies for operating engine 14.

By using engine control strategies tailored for the different operating states of clutch 32, the disclosed embodiments may provide certain performance advantages. For example, the disclosed embodiments may provide a desirable combination of high average fuel efficiency and low average emissions when clutch 32 is disengaged. When clutch 32 is disengaged, providing high engine fuel efficiency at a speed and torque that corresponds to the drive speed/reaction torque band B_{s/t} of torque converter 16 may provide high average fuel efficiency because engine 14 may operate at or near this speed and torque a high percentage of the time when torque converter 16 is transmitting power. Additionally, by providing lower noxious exhaust emissions at one or more other combinations of engine speed and torque, the disclosed embodiments may suppress the average noxious exhaust emissions that engine 14 produces when clutch 32 is disengaged.

Similarly, the disclosed embodiments may provide high average fuel efficiency and low average noxious exhaust emissions when clutch 32 is engaged. As mentioned above, with clutch 32 engaged, engine controls 39 may operate engine 14 at relatively low speeds and high torques a high percentage of the time. Accordingly, when clutch 32 is engaged, using a control strategy that provides high engine fuel efficiency at a relatively low engine speed and high torque output may result in relatively high average fuel efficiency. Additionally, by providing low noxious exhaust emissions at one or more other combinations of engine speed and torque, the disclosed embodiments may suppress the average noxious exhaust emissions that engine 14 produces when clutch 32 is engaged.

It will be apparent to those skilled in the art that various modifications and variations can be made in the disclosed power system and control methods without departing from the scope of the disclosure. Other embodiments of the disclosed power system and control methods will be apparent to those skilled in the art from consideration of the specification and practice of the power system and control method disclosed herein. It is intended that the specification and examples be considered as exemplary only, with a true scope of the disclosure being indicated by the following claims and their equivalents.

What is claimed is:

1. A power system, including:
an engine having engine controls;
a power load;
a torque converter connected between the engine and the power load;
wherein the engine controls operate the engine according to a first control strategy in at least some circumstances;
wherein the first control strategy provides higher engine fuel efficiency at a first combination of engine speed and torque that corresponds to the drive speed/reaction torque band of the torque converter than it does at combinations of engine speed and torque that do not correspond to the drive speed/reaction torque band; and
wherein, at one or more combinations of engine speed and torque other than the first combination, the first control strategy causes the engine to produce a lower quantity of at least one noxious exhaust emission than the engine produces at the first combination of engine speed and torque when operated according to the first control strategy.

2. The power system of claim 1, wherein:
the engine controls operate the engine according to a second control strategy in at least some circumstances; and
the second control strategy provides higher engine fuel efficiency at a second combination of engine speed and torque than it does at the first combination of engine speed and torque.

3. The power system of claim 2, wherein, at one or more combinations of engine speed and torque other than the second combination, the second control strategy causes the engine to produce a lower quantity of at least one noxious exhaust emission than the engine produces at the second combination of engine speed and torque when operated according to the second control strategy.

4. The power system of claim 2, wherein the engine speed of the second combination of engine speed and torque is lower than the engine speed of the first combination of engine speed and torque.

5. The power system of claim 2, further including:
a clutch having an input side drivingly connected to the engine and an output side drivingly connected to the power load; and
wherein whether the engine controls operate the engine according to the second control strategy depends at least in part on the operating state of the clutch.

6. The power system of claim 2, further including:
a clutch having an input side drivingly connected to the engine and an output side drivingly connected to the power load; and
whether the engine controls operate the engine according to the first control strategy depends at least in part on the operating state of the clutch.

7. The power system of claim 1, further including:
a clutch having an input side drivingly connected to the engine and an output side drivingly connected to the power load; and
whether the engine controls operate the engine according to the first control strategy depends at least in part on the operating state of the clutch.

8. The power system of claim 1, further including:
a clutch having an input side drivingly connected to the engine and an output side drivingly connected to the power load; and
the engine controls operate the engine according to the first control strategy only if the clutch is disengaged.

9. The power system of claim 1, wherein:
the power system is part of a machine; and
the power load includes one or more propulsion devices for propelling the machine with power from the engine.

10. A method of operating a power system that has an engine, a power load, and a torque converter connected between the engine and the power load, the method comprising:
operating the engine according to a first control strategy in at least some circumstances;
wherein the first control strategy provides higher engine fuel efficiency at a first combination of engine speed and torque that corresponds to a drive speed/reaction torque band of the torque converter than it does at combinations of engine speed and torque that do not correspond to the drive speed/reaction torque band; and
wherein, at one or more combinations of engine speed and torque other than the first combination, the first control strategy causes the engine to produce a lower quantity of at least one noxious exhaust emission than the engine produces at the first combination of engine speed and torque when operated according to the first control strategy.

11. The method of claim 10, wherein:
the power system further includes a clutch having an input side drivingly connected to the engine and an output side drivingly connected to the power load; and
the method further includes determining when to operate the engine according to the first control strategy based at least partially on the operating state of the clutch.

12. The method of claim 10, wherein:
the power system further includes a clutch having an input side drivingly connected to the engine and an output side drivingly connected to the power load; and
operating the engine according to the first control strategy in at least some circumstances includes operating the engine according to the first control strategy only when the clutch is disengaged.

13. The method of claim 10, further including:
operating the engine according to a second control strategy in at least some circumstances; and
wherein the second control strategy provides higher engine fuel efficiency at a second combination of engine speed and torque than it does at the first combination of engine speed and torque.

14. The method of claim 13, wherein, at one or more combinations of engine speed and torque other than the second combination, the second control strategy causes the engine to produce a lower quantity of at least one noxious exhaust emission than the engine produces at the second combination of engine speed and torque when operated according to the second control strategy.

15. The method of claim 13, wherein the engine speed of the second combination of engine speed and torque is lower than the engine speed of the first combination of engine speed and torque.

16. The method of claim 13, wherein:
the power system further includes a clutch having an input side drivingly connected to the engine and an output side drivingly connected to the power load; and
the method further includes determining whether to operate the engine according to the second control strategy based at least in part on the operating state of the clutch.

17. A power system, including:
an engine having engine controls;
a power load;
a torque converter connected between the engine and the power load;
a clutch having an input side drivingly connected to the engine and an output side drivingly connected to the power load; and
wherein the engine controls operate the engine according to a first control strategy in response to the clutch being disengaged, and the engine controls operate the engine according to a second control strategy in response to the clutch being engaged.

18. The power system of claim 17, wherein:
the first control strategy provides higher engine fuel efficiency at a first combination of engine speed and torque than it does at a second combination of engine speed and torque; and
the second control strategy provides higher engine fuel efficiency at the second combination of engine speed and torque than it does at the first combination of engine speed and torque.

19. The power system of claim 18, wherein the engine speed of the first combination of engine speed and torque is higher than the engine speed of the second combination of engine speed and torque.

20. The power system of claim 17, wherein:
when operating the engine according to the first control strategy, the engine controls deliver fuel to the engine based on a first fuel map; and
when operating the engine according to the second control strategy, the engine controls deliver fuel to the engine based on a second fuel map.
